(19) United States
(12) Patent Application Publication
(10) Pub. No.: US 2011/0080474 A1
(43) Pub. Date: Apr. 7, 2011

(54) IMAGE PICKUP DEVICE, IMAGE PICKUP UNIT, AND ENDOSCOPE

(75) Inventor: Takatoshi IGARASHI, Kamiina-gun (JP)

(73) Assignee: OLYMPUS CORPORATION, Tokyo (JP)

(21) Appl. No.: 12/896,225

(22) Filed: Oct. 1, 2010

(30) Foreign Application Priority Data
Oct. 2, 2009 (JP) 2009-230871

(51) Int. Cl. H04N 7/18; H04N 5/335

(52) U.S. Cl. 348/65; 348/294; 348/E05.091; 348/E07.085

(57) ABSTRACT

An image pickup device according to the present invention including an image pickup device main body having a semiconductor substrate provided with a light-receiving section and a wiring layer laminated on the semiconductor substrate, has a first surface which causes light to enter the light-receiving section and positioned on the image pickup device main body on the side of the wiring layer and a second surface which causes light to enter the light-receiving section and positioned on the image pickup device main body on the side of the semiconductor substrate so as to oppose the first surface.

### CROSS REFERENCE TO RELATED APPLICATION

This application claims benefit of Japanese Application No. 2009-230871 filed in Japan on Oct. 2, 2009, the contents of which are incorporated by this reference.

### BACKGROUND OF THE INVENTION

1. Field of the Invention

The present invention relates to an image pickup device, an image pickup unit, and an endoscope including an image pickup device main body having two surfaces into which light enters from two opposing directions.

2. Description of the Related Art

Conventionally, solid-state image pickup devices (hereinafter simply referred to as image pickup devices) such as CCDs and CMOSs, which pick up images of a subject by converting light entering a light-receiving section provided on a semiconductor substrate into an electrical signal, are well known.

Moreover, well-known image pickup devices include a front side illuminated image pickup device which picks up an image by receiving light from the front side of the image pickup device or, more specifically, from the side of a wiring layer laminated on a semiconductor substrate, and a backside illuminated image pickup device which picks up an image by receiving light from the backside of the image pickup device which opposes the front side or, more specifically, from the side of the semiconductor substrate and which has a higher photosensitivity than a front side illuminated image pickup device. In addition, such an image pickup device is used in electronic endoscopes, camera-equipped cell-phones, digital cameras, and the like as an image pickup unit in combination with an objective optical system.

In addition, Japanese Patent Application Laid-Open Publication No. 2008-227250 discloses an image pickup device capable of picking up two images of a same subject at the same time by installing two solid-state image pickup devices so as to overlap each other along entrance directions of light, having a light-receiving section of one of the solid-state image pickup devices receive light entering from the backside of the one of the solid-state image pickup devices, and having a light-receiving section of the other solid-state image pickup device receive light allowed to enter from the backside of the one of the solid-state image pickup devices, passing through the one of the solid-state image pickup devices, and entering from the backside of the other solid-state image pickup device.

### SUMMARY OF THE INVENTION

In simple terms, an image pickup device according to the present invention includes two surfaces into which light enters from two opposing directions.

The above and other objects, features and advantages of the invention will become more clearly understood from the following description referring to the accompanying drawings.

### BRIEF DESCRIPTION OF THE DRAWINGS

FIG. 1 is a diagram of an image pickup apparatus including an image pickup device according to a first embodiment;

FIG. 2 is a partially enlarged view schematically illustrating a configuration of the image pickup device illustrated in FIG. 1;

FIG. 3 is a diagram of an image pickup apparatus including an image pickup device according to a second embodiment;

FIG. 4 is a partially enlarged view schematically illustrating a configuration of the image pickup device illustrated in FIG. 3;

FIG. 5 is a partially enlarged view schematically illustrating a configuration of an image pickup device according to a third embodiment;

FIG. 6 is a partially enlarged view schematically illustrating a configuration of an image pickup device according to a fourth embodiment;

FIG. 7 is a diagram illustrating an image pickup unit to which the image pickup device illustrated in FIG. 1 has been fixed;

FIG. 8 is a diagram illustrating a state where a distal end portion of an insertion portion of an endoscope provided with the image pickup unit illustrated in FIG. 7 has been inserted inside a body cavity;

FIG. 9 is a diagram illustrating a modification in which an optical path conversion element including a lens unit has been provided on a second side of the image pickup device illustrated in FIG. 8; and

FIG. 10 is a diagram illustrating a state where a distal end portion of an insertion portion of an endoscope provided with the image pickup unit illustrated in FIG. 9 has been inserted inside a stomach.

### DETAILED DESCRIPTION OF THE PREFERRED EMBODIMENTS

Hereinafter, embodiments of the present invention will be described with reference to the drawings. It should be noted that the drawings are merely schematic and that the relationship between a thickness and a width of each member, ratios between thicknesses of the respective members, and the like may differ from actual measurements. Moreover, it should be obvious that relationships and ratios of measurements presented in the drawings may include portions that differ among the drawings.

### First Embodiment

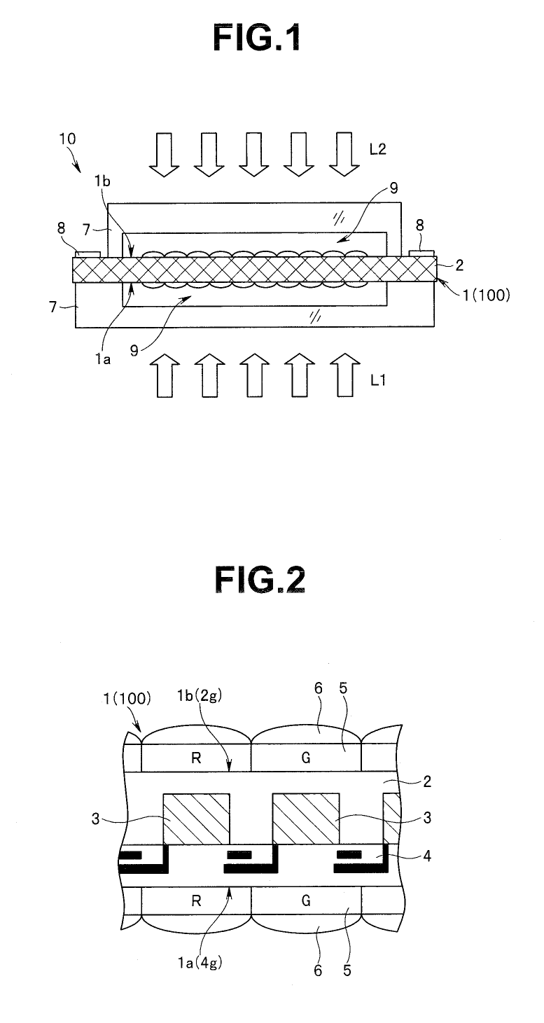

FIG. 1 is a diagram of an image pickup apparatus including an image pickup device according to the present embodiment, and FIG. 2 is a partially enlarged view schematically illustrating a configuration of the image pickup device illustrated in FIG. 1.

As illustrated in FIG. 2, an image pickup device 1 made of a single image pickup device main body 100 includes: a semiconductor substrate 2 provided with a light-receiving section 3; and a wiring layer 4 which is laminated on the semiconductor substrate 2 and which transmits an electrical signal photoelectrically converted by the light-receiving section 3 to a peripheral circuit, not shown, of the image pickup device 1. Moreover, in the present embodiment, the semiconductor substrate 2 is extremely thinly formed so as to have a thickness of, for example, 3 μm to 10 μm.

In addition, a first surface 1a that causes light to enter the light-receiving section 3 is formed on the image pickup device 1 on the side of the wiring layer 4 and a second surface 1b is formed so as to oppose the first surface 1a on the image pickup device 1 on the side of the semiconductor substrate 2. In other words, the image pickup device 1 has a configuration such that light can enter the light-receiving section 3 from two different entrance directions that differ from each other by 180°.

A color filter 5 and a microlens 6 are sequentially laminated on the first surface 1a or, in other words, on an outer surface 4g of the wiring layer 4, and as illustrated in FIG. 1, a cover glass 7 is fixed onto the outer surface 4g so as to cover the microlens 6 in a plan-viewed state.

An air layer 9 for enhancing the light-gathering effect of the microlens or, in other words, for enhancing the photosensitivity of a light L1 entering the light-receiving section 3 via the first surface 1a, is interposed between the cover glass 7 and the microlens 6.

Returning now to FIG. 2, a color filter 5 and a microlens 6 are also sequentially laminated on the second surface 1b or, in other words, on an outer surface 2g of the semiconductor substrate 2, and as illustrated in FIG. 1, a cover glass 7 is fixed onto the outer surface 2g so as to cover the microlens 6 on the side of the second surface 1b in a plan-viewed state. Moreover, in the present embodiment, a structural body in which cover glasses 7 are respectively fixed to the image pickup device 1 is to be referred to as an image pickup apparatus 10.

An air layer 9 for enhancing the light-gathering effect of the microlens 6 or, in other words, enhancing the photosensitivity of a light L2 entering the light-receiving section 3 via the second surface 1b, is interposed between the cover glass 7 and the microlens 6.

After being fixed, the cover glass 7 improves the mechanical strength of the semiconductor substrate 2. As described earlier, the semiconductor substrate 2 is extremely thinly formed so as to have a thickness of 3 μm to 10 μm and is deformable when used alone. Therefore, a supporting substrate normally must be fixed to the semiconductor substrate 2 in order to improve the mechanical strength of the semiconductor substrate 2. However, in the present configuration, a supporting substrate is not required because the cover glass 7 functions as a supporting substrate.

In addition, the semiconductor substrate 2 is extremely thinly formed because a thickness of, for example, around several hundred μm prevents the light L2 from entering the light-receiving section 3 via the second surface 1b, given that the reachable distance of light is around several μm to several ten μm.

Furthermore, as illustrated in FIG. 1, an electrode pad 8 electrically connected to the aforementioned peripheral circuit of the image pickup device 1 is formed on the outer surface 2g of the semiconductor substrate 2. Since the electrode pad 8 is not covered by the cover glass 7, the electrode pad 8 is positioned in an exposed state in the image pickup device 1.

An external substrate, not shown, is electrically connected to the electrode pad 8. Accordingly, power is supplied to the image pickup device 1 from the external substrate via the electrode pad 8. In addition, the image pickup device 1 transmits/receives electrical signals to/from the external substrate via the electrode pad 8.

Moreover, the image pickup device 1 according to the present embodiment includes a light-shielding member, not shown, which shields the second surface 1b when light enters the light-receiving section 3 from the first surface 1a and which shields the first surface 1a when light enters the light-receiving section 3 from the second surface 1b.

Known mechanical shutters, liquid crystal shutters, and the like can be used as the light-shielding member. When shooting a moving image using the image pickup device 1, the light-shielding member is to alternate between shielding the first surface 1a and shielding the second surface 1b according to time.

As shown, in the present embodiment, the image pickup device 1 has a configuration such that lights L1 and L2 can enter the light-receiving section 3 from two entrance directions that differ from each other by 180°. More specifically, the first surface 1a that causes light to enter the light-receiving section 3 is formed on the image pickup device 1 on the side of the wiring layer 4 and the second surface 1b is formed so as to oppose the first surface 1a on the image pickup device 1 on the side of the semiconductor substrate 2.

Accordingly, since images can be picked up in two directions with one image pickup device, the image pickup device 1 is capable of picking up images in two directions with a simple and thin construction without having to change the orientation of the image pickup device.

Consequently, the image pickup device 1 can be provided which has a configuration that enables images of two subjects positioned at different locations to be acquired in a simple manner without having to change the orientation of the image pickup device 1.

### Second Embodiment

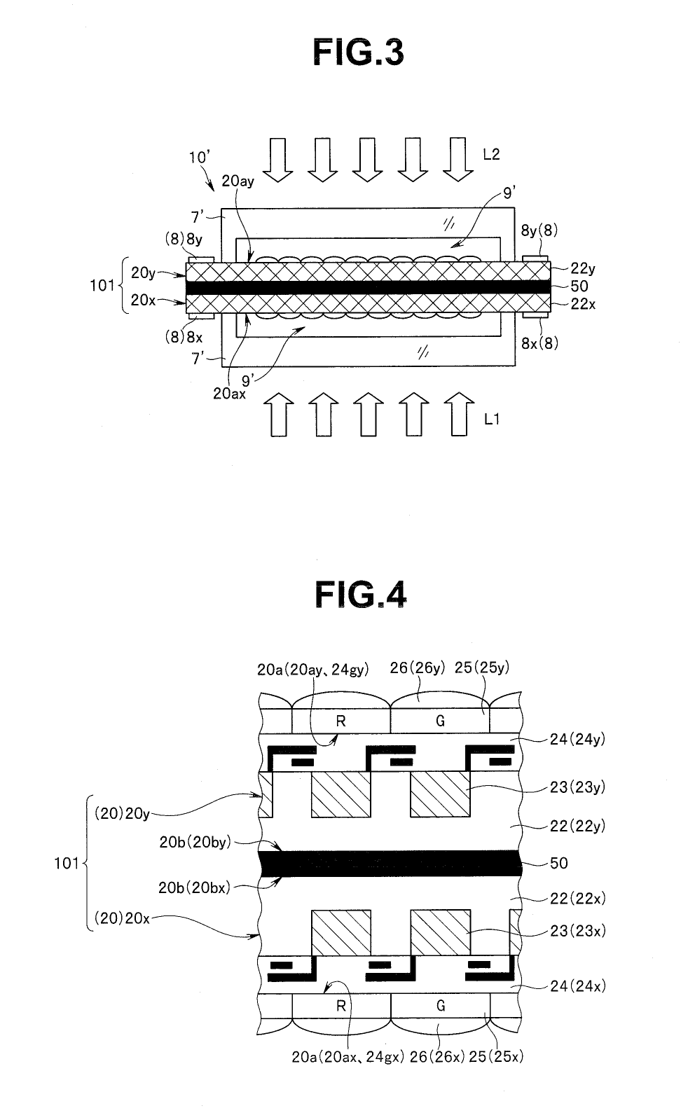

FIG. 3 is a diagram of an image pickup apparatus including an image pickup device according to the present embodiment, and FIG. 4 is a partially enlarged view schematically illustrating a configuration of the image pickup device illustrated in FIG. 3.

The configuration of the image pickup device according to the second embodiment differs from the image pickup device according to the first embodiment described above and illustrated in FIGS. 1 and 2 in that the image pickup device is made up of two image pickup device main bodies. Therefore, only this difference will be described. Components similar to those of the first embodiment are to be denoted by the same reference characters and a description thereof will be omitted.

As illustrated in FIG. 4, in the present embodiment, an image pickup device 101 is made up of two image pickup device main bodies 20x and 20y by having another image pickup device main body 20y adhere to one image pickup device main body 20x.

Specifically, as illustrated in FIG. 4, the image pickup device main body 20x includes a semiconductor substrate 22x provided with a light-receiving section 23x and a wiring layer 24x which is laminated on the semiconductor substrate 22x and which transmits an electrical signal photoelectrically converted by the light-receiving section 23x to a peripheral circuit, not shown, of the image pickup device 101. Moreover, in the present embodiment, the semiconductor substrate 22x is formed thicker than the semiconductor substrate 2 of the image pickup device 1 according to the first embodiment described above.

In addition, a first surface 20ax that causes light to enter the light-receiving section 23x is formed on the image pickup device main body 20x on the side of the wiring layer 24x, and a second surface 20bx is formed so as to oppose the first surface 20ax on the image pickup device main body 20x on the side of the semiconductor substrate 22x.

A color filter 25x and a microlens 26x are sequentially laminated on the first surface 20ax or, in other words, on an outer surface 24gx of the wiring layer 24x, and as illustrated in FIG. 3, a cover glass 7′ is fixed onto the outer surface 24gx so as to cover the microlens 26x in a plan-viewed state.

An air layer 9′ for enhancing the light-gathering effect of the microlens 6′ or, in other words, enhancing the photosensitivity of a light L1 entering the light-receiving section 23x via the first surface 20ax, is interposed between the cover glass 7′ and the microlens 6′.

The image pickup device main body 20y includes a semiconductor substrate 22y provided with a light-receiving section 23y and a wiring layer 24y which is laminated on the semiconductor substrate 22y and which transmits an electrical signal photoelectrically converted by the light-receiving section 23y to a peripheral circuit, not shown, of the image pickup device 101. Moreover, in the present embodiment, the semiconductor substrate 22y is formed thicker than the semiconductor substrate 2 of the image pickup device 1 according to the first embodiment described above.

In addition, a first surface 20ay that causes light to enter the light-receiving section 23y is formed on the image pickup device main body 20y on the side of the wiring layer 24y, and a second surface 20by is formed so as to oppose the first surface 20ay on the image pickup device main body 20y on the side of the semiconductor substrate 22y.

A color filter 25y and a microlens 26y are sequentially laminated on the first surface 20ay or, in other words, on an outer surface 24gy of the wiring layer 24y, and as illustrated in FIG. 3, the cover glass 7′ is fixed onto the outer surface 24gy so as to cover the microlens 26y in a plan-viewed state. Moreover, in the present embodiment, a structural body in which the cover glass 7′ is fixed to the image pickup device 101 is to be referred to as an image pickup apparatus 10′.

An air layer 9′ for enhancing the light-gathering effect of the microlens 6′ or, in other words, enhancing the photosensitivity of a light L2 entering the light-receiving section 23y via the first surface 20ay, is interposed between the cover glass 7′ and the microlens 6′.

The image pickup device 101 according to the present embodiment is configured by having the second surface 20bx of the image pickup device main body 20x and the second surface 20by of the image pickup device main body 20y adhere to each other via a light-shielding layer 50.

Moreover, while the adhesion may be performed either on a wafer level in which a large board made up of a plurality of image pickup device main bodies 20x and a large board made up of a plurality of image pickup device main bodies 20y are adhered to each other or on a chip level in which a singulated image pickup device main body 20x and a singulated image pickup device main body 20y are adhered to each other, the adhesion is preferably performed on a wafer level in consideration of productivity.

In addition, the image pickup device main body 20x and the image pickup device main body 20y have the same structure that is a known front side illuminated image pickup device structure.

Therefore, the image pickup device 101 is configured such that lights L1 and L2 respectively enter at least one of the light-receiving section 23x of the image pickup device main body 20x and the light-receiving section 23y of the image pickup device main body 20y via the first surfaces 20ax and 20ay.

In other words, since the image pickup device 101 is configured such that light can enter the light-receiving section 23x from one direction and light can enter the light-receiving section 23y from one direction, the image pickup device 101 is configured such that light can enter from two directions that differ from each other by 180°.

The light-shielding layer 50 functions to prevent light via the first surface 20ay of the image pickup device main body 20y from entering the light-receiving section 23x and to prevent light via the first surface 20ax of the image pickup device main body 20x from entering the light-receiving section 23y, and is made of a metallic layer such as Cr, Ni, and Al or a resin material such as epoxy resin, alkaline resin, and silicon resin containing a black pigment.

Moreover, the light-shielding layer 50 is not indispensable when the thickness of each of the semiconductor substrates 22x and 22y is sufficient, that is equal to or greater than several hundred μm. This is because when the thickness of the semiconductor substrate 22x is sufficient, light via the first surface 20ax of the image pickup device main body 20x is to be absorbed by the semiconductor substrate 22x and does not reach the light-receiving section 23y of the image pickup device main body 20y.

In a similar manner, when the thickness of the semiconductor substrate 22y is sufficient, light via the first surface 20ay of the image pickup device main body 20y is to be absorbed by the semiconductor substrate 22y and does not reach the light-receiving section 23x of the image pickup device main body 20x.

Furthermore, the light-shielding layer 50 may have a function of an adhesive for adhering together the second surface 20bx of the image pickup device main body 20x and the second surface 20by of the image pickup device main body 20y.

In addition, since light does not enter from the sides of the semiconductor substrates 22x and 22y in an image pickup device having a front side illuminated structure, each of the substrates 22x and 22y is formed thicker than in a backside illuminated image pickup device in the thickness direction in order to improve the mechanical strength of each of the substrates 22x and 22y.

Furthermore, as illustrated in FIG. 3, an electrode pad 8x electrically connected to a peripheral circuit of the image pickup device 101 is formed on the first surface 20ax of the image pickup device main body 20x and, at the same time, an electrode pad 8y electrically connected to a peripheral circuit of the image pickup device 101 is also formed on the first surface 20ay of the image pickup device main body 20y.

Since the electrode pads 8x and 8y are not covered by the cover glass 7′, the electrode pads 8x and 8y are positioned in an exposed state in the image pickup device 101.

Moreover, the electrode pads 8x and 8y may be formed aggregated on either the first surface 20ax of the image pickup device main body 20x or the first surface 20ay of the image pickup device main body 20y using a known TSV (Through Silicon Via).

As shown, in the present embodiment, the image pickup device 101 is formed by adhering the second surface 20by of the image pickup device main body 20y onto the second surface 20bx of the image pickup device main body 20x.

In addition, as shown, a light L1 enters the light-receiving section 23x of the image pickup device main body 20x via the first surface 20ax and a light L2 enters the light-receiving section 23y of the image pickup device main body 20y via the first surface 20ay.

Consequently, while the light-shielding member only allowed one of the light L1 and the light L2 to be received in the image pickup device 1 according to the first embodiment, with the image pickup device 101 according to the present embodiment, lights L1 and L2 whose entrance directions differ from each other by 180° can be received at the same time.

As a result, also with the present embodiment, the image pickup device 101 can be provided which has a configuration that enables images of two subjects positioned at different locations to be acquired in a simple manner without having to change the orientation of the image pickup device 101.

### Third Embodiment

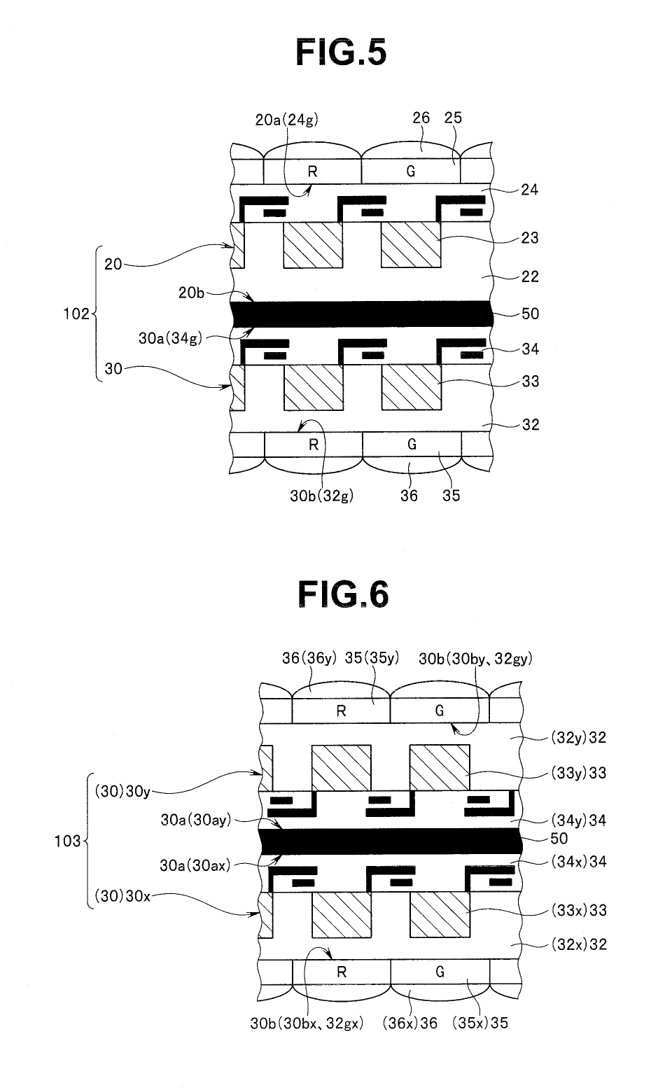

FIG. 5 is a partially enlarged view schematically illustrating a configuration of an image pickup device according to the present embodiment.

The configuration of the image pickup device according to the third embodiment differs from the image pickup device according to the second embodiment described above and illustrated in FIGS. 3 and 4 in that an image pickup device is formed by adhering together an image pickup device main body having a front side illuminated structure and an image pickup device main body having a backside illuminated structure. Therefore, only this difference will be described. Components similar to those of the second embodiment are to be denoted by the same reference characters and a description thereof will be omitted.

As illustrated in FIG. 5, in the present embodiment, an image pickup device 102 is made up of two image pickup device main bodies 20 and 30 by having another image pickup device main body 20 adhere to one image pickup device main body 30.

Moreover, since the configuration of one of the image pickup device main bodies 20 is the same as the image pickup device main body 20x or the image pickup device main body 20y shown in the second embodiment, a description thereof will be omitted. Therefore, only the configuration of the image pickup device main body 30 will be described.

Specifically, as illustrated in FIG. 5, the image pickup device main body 30 has a known backside illuminated image pickup device structure, and includes a semiconductor substrate 32 provided with a light-receiving section 33 and a wiring layer 34 which is laminated on the semiconductor substrate 32 and which transmits an electrical signal photoelectrically converted by the light-receiving section 33 to a peripheral circuit, not shown, of the image pickup device 102. Moreover, in the present embodiment, the semiconductor substrate 32 is formed to the same thickness as the semiconductor substrate 2 of the image pickup device 1 according to the first embodiment described above.

In addition, a first surface 30a is formed on the image pickup device main body 30 on the side of the wiring layer 34 and a second surface 30b that causes light to enter the light-receiving section 33 is formed so as to oppose the first surface 30a on the image pickup device main body 30 on the side of the semiconductor substrate 32.

A color filter 35 and a microlens 36 are sequentially laminated on the second surface 30b or, in other words, on an outer surface 32g of the semiconductor substrate 32.

The image pickup device 102 according to the present embodiment is formed by adhering the first surface 30a of the image pickup device main body 30 to a second surface 20b of the image pickup device main body 20 via a light-shielding layer 50.

Therefore, the image pickup device 102 is configured such that lights L1 and L2 respectively enter at least one of the light-receiving section 33 of the image pickup device main body 30 and a light-receiving section 23 of the image pickup device main body 20 via the second surface 30b and a first surface 20a.

In other words, since the image pickup device 102 is configured such that light can enter the light-receiving section 33 from one direction and light can enter the light-receiving section 23 from one direction, the image pickup device 102 is configured such that light can enter from two directions that differ from each other by 180°.

Moreover, in the present embodiment, a structural body in which a cover glass 7′ is fixed to the image pickup device 102 is to be referred to as an image pickup apparatus 10′.

Again, in the present embodiment, the light-shielding layer 50 is not indispensable when a semiconductor substrate 22 has a sufficient thickness that equals or exceeds several hundred μm for the same reason as in the second embodiment.

In addition, since the image pickup device main body 30 has a backside illuminated image pickup device structure and is configured such that light is to enter the light-receiving section 33 from the side of the second surface 30b, the semiconductor substrate 32 is extremely thinly formed so as to have a thickness of 3 μm to 10 μm.

Therefore, as shown in the first embodiment, although the mechanical strength of the semiconductor substrate 32 is normally maintained by adhering either a supporting substrate or a cover glass 7, in the present embodiment, the image pickup device main body 20 to be adhered to the image pickup device main body 30 has a function of a supporting substrate. In other words, the image pickup device main body 20 functions to improve the mechanical strength of the semiconductor substrate 32 of the image pickup device main body 30.

Accordingly, since a process of adhering a supporting substrate to the semiconductor substrate 32 or the like becomes unnecessary, the image pickup device main body 30 can be manufactured by the same manufacturing process as a conventional backside illuminated image pickup device.

In addition, with the image pickup device 102 according to the present embodiment, since an outer surface 34g of the wiring layer 34 of the image pickup device main body 30 or, in other words, the first surface 30a is adhered to the second surface 20b of the image pickup device main body 20, an electrode pad 8 of the image pickup device main body 30 cannot be formed on the outer surface 34g.

For this reason, the electrode pad 8 of the image pickup device main body 30 may be formed aggregated using the aforementioned TSV with the electrode pad 8 of the image pickup device main body 20 on an outer surface 24g of a wiring layer 24 of the image pickup device main body 20 or formed on the outer surface 32g of the semiconductor substrate 32 of the image pickup device main body 30 using a TSV. Furthermore, the electrode pads of the image pickup device main bodies 30 and 20 may be formed aggregated on the outer surface 32g.

As shown, in the present embodiment, the image pickup device 102 is formed by adhering the second surface 20b of the image pickup device main body 20 onto the first surface 30a of the image pickup device main body 30.

In addition, as shown, a light L1 enters the light-receiving section 33 of the image pickup device main body 30 via the second surface 30b and a light L2 enters the light-receiving section 23 of the image pickup device main body 20 via the first surface 20a. Furthermore, as shown, the image pickup device main body 30 has a backside illuminated image pickup device structure.

Consequently, in addition to the effect of the second embodiment described above, since the image pickup device main body 30 has a backside illuminated image pickup device structure, the image pickup device 102 whose photosensitivity has been improved in comparison to the image pickup device 101 shown in the second embodiment can be provided.

As a result, also with the present embodiment, the image pickup device 102 can be provided which has a configuration that enables images of two subjects positioned at different locations to be acquired in a simple manner without having to change the orientation of the image pickup device 102.

Moreover, while the present embodiment has been configured such that the image pickup device main body 30 is used as the one of the image pickup device main bodies and the image pickup device main body 20 is used as the other of the image pickup device main bodies, the configuration is not restrictive. Alternatively, the image pickup device main body 20 may be used as the one of the image pickup device main bodies and the image pickup device main body 30 may be used as the other of the image pickup device main bodies.

### Fourth Embodiment

FIG. 6 is a partially enlarged view schematically illustrating a configuration of an image pickup device according to the present embodiment.

The configuration of the image pickup device according to the fourth embodiment differs from the aforementioned image pickup device according to the second embodiment illustrated in FIGS. 3 and 4 as well as the aforementioned image pickup device according to the third embodiment illustrated in FIG. 5 in that an image pickup device is formed by two image pickup device main bodies having a backside illuminated image pickup device structure. Therefore, only this difference will be described. Components similar to those of the first embodiment are to be denoted by the same reference characters and a description thereof will be omitted.

Moreover, since the configuration of two image pickup device main bodies 30x and 30y used in the present embodiment shares the same structure as the image pickup device main body 30 described above in the third embodiment, a detailed description thereof will be omitted.

As illustrated in FIG. 6, in the present embodiment, an image pickup device 103 is made up of two image pickup device main bodies 30x and 30y by having another image pickup device main body 30y adhere to one image pickup device main body 30x.

In addition, the image pickup device 103 is configured by adhering a first surface 30ax of the image pickup device main body 30x to a first surface 30ay of the image pickup device main body 30y via a light-shielding layer 50.

The image pickup device 103 is configured such that lights L1 and L2 respectively enter at least one of a light-receiving section 33x of the image pickup device main body 30x and a light-receiving section 33y of the image pickup device main body 30y via second surfaces 30bx and 30by.

In other words, since the image pickup device 103 is configured such that light can enter the light-receiving section 33x from one direction and light can enter the light-receiving section 33y from one direction, the image pickup device 103 is configured such that light can enter from two directions that differ from each other by 180°.

Moreover, in the present embodiment, a structural body in which a cover glass 7′ is fixed to the image pickup device 103 is to be referred to as an image pickup apparatus 10′.

Furthermore, while not shown, an electrode pad electrically connected via the aforementioned TSV to a peripheral circuit of the image pickup device 103 is formed on the second surface 30bx of the image pickup device main body 30x and an electrode pad electrically connected via the TSV to a peripheral circuit of the image pickup device 103 is formed on the second surface 30by of the image pickup device main body 30y. Alternatively, electrode pads of the image pickup device main bodies 30x and 30y may be formed aggregated on one of the second surface 30bx of the image pickup device main body 30x and the second surface 30by of the image pickup device main body 30y.

As shown, in the present embodiment, the image pickup device 103 is formed by adhering the first surface 30ay of the image pickup device main body 30y to the first surface 30ax of the image pickup device main body 30x.

In addition, as shown, a light L1 enters the light-receiving section 33x of the image pickup device main body 30x via the second surface 30bx and a light L2 enters the light-receiving section 33y of the image pickup device main body 30y via the second surface 30by.

Consequently, in addition to the effects of the second and third embodiments described above, since the image pickup device main body 30x and the image pickup device main body 30y have a backside illuminated image pickup device structure, the image pickup device 103 with improved photosensitivity can be provided.

As a result, also with the present embodiment, the image pickup device 103 can be provided which has a configuration that enables images of two subjects positioned at different locations to be acquired in a simple manner without having to change the orientation of the image pickup device 103.

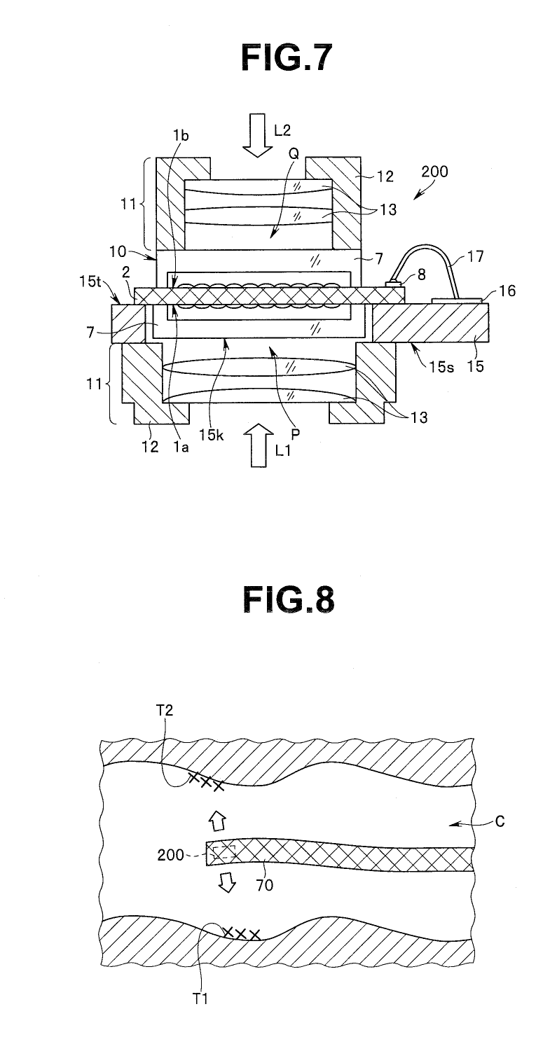

Moreover, the image pickup apparatus 10 including the image pickup device 1 according to the first embodiment and the image pickup apparatus 10′ including the image pickup devices 102 to 104 according to the second to fourth embodiments respectively configured as described above are to be provided in an image pickup unit. Hereinafter, configurations of an image pickup unit will be shown with reference to FIGS. 7 and 8. In addition, hereinafter, an image pickup apparatus to be used in the image pickup units will be described taking the image pickup apparatus 10 shown in the first embodiment as an example.

FIG. 7 is a diagram illustrating an image pickup unit to which the image pickup apparatus illustrated in FIG. 1 has been fixed, and FIG. 8 is a diagram illustrating a state where a distal end portion of an insertion portion of an endoscope provided with the image pickup unit illustrated in FIG. 7 has been inserted inside a body cavity.

As illustrated in FIG. 7, in an image pickup unit 200, the image pickup apparatus 10 is fixed to an outer substrate 15 that is a member to be fixed.

Specifically, an opening 15k that penetrates the outer substrate 15 in a thickness direction thereof is formed in the outer substrate 15. The opening 15k is formed at a position on a surface 15t on the side of a second side Q of the outer substrate 15 at which, when a semiconductor substrate 2 of the image pickup device 1 is fixed, a light-receiving section 3 of the image pickup device 1 becomes exposed on the outside of the outer substrate 15. Specifically, the opening 15k is formed at a position on the outer substrate 15 which the light-receiving section 3 of the image pickup device 1 overlaps in a plan-viewed state. The opening 15k is an opening formed in order to allow light entering from a first side P, to be described later, to enter a first surface 1a of the image pickup device.

Moreover, a terminal 16 to which an electrode pad 8 of the image pickup device 1 is to be electrically connected via a wiring 17 is provided on the surface 15t of the outer substrate 15.

Furthermore, in the image pickup unit 200, lens units 11 that are optical elements are respectively provided on the first side P of the image pickup device 1 which overlaps the light-receiving section 3 via the opening 15k in a plan-viewed state and on the second side Q of the image pickup device 1 that is opposite to the first side P of the image pickup device 1 which overlaps the light-receiving section 3 in a plan-viewed state.

A lens frame 12 and a lens 13 held by the lens frame 12 make up a primary portion of the lens unit 11.

The lens frame 12 of the lens unit 11 positioned on the first side P is fixed to a surface 15s on the side opposite to the surface 15t of the outer substrate 15 so that the lens 13 opposes the light-receiving section 3 of the image pickup device 1. In addition, the lens frame 12 of the lens unit 11 positioned on the second side Q is fixed to a cover glass 7 so that the lens 13 opposes the light-receiving section 3 of the image pickup device 1. Accordingly, the lens units 11 are respectively provided on the first side P and the second side Q of the image pickup device 1.

As a result, a configuration is realized in which a light L1 that passes through the lens 13 of the lens unit 11 positioned on the first side P, a microlens 6, and a color filter 5 enters the first surface 1a of the image pickup device 1 and a light L2 that passes through the lens 13 of the lens unit 11 positioned on the second side Q, the microlens 6, and the color filter 5 enters a second surface 1b of the image pickup device 1.

The image pickup unit 200 configured as described above is capable of picking up images of two subjects positioned in directions that differ from each other or, more specifically, two subjects positioned in directions that differ from each other by 180°, using a single image pickup device 1.

By using a lens capable of 180° observation as the lens 13 of each lens unit 11, an image pickup unit can be provided which is capable of 360° observation.

Therefore, by using the image pickup unit 200 having the present configuration in, for example, a mobile phone, a single image pickup unit 200 can double as a known in-camera and out-camera of the mobile phone, thereby achieving downsizing of the mobile phone.

In addition, as illustrated in FIG. 8, by providing the image pickup unit 200 inside a distal end of an insertion portion 70 of an endoscope, sites T1 and T2 in a body cavity C in directions that differ from each other by 180° can be observed by a single image pickup unit 200. As a result, a small-size and small-diameter endoscope with binocular side-viewing can be realized. An endoscope with binocular side-viewing is particularly effective when observing tubular organs such as the esophagus and the intestine. The use of the present endoscope enables observations with less oversight.

Moreover, in the present embodiment, while it is shown that the image pickup apparatus 10 including the image pickup device 1 shown in the first embodiment is to be used in the image pickup unit 200, such a configuration is not restrictive and the image pickup apparatus 10′ including any of the image pickup devices 101 to 103 according to the second to fourth embodiments may be used instead. In this case, the image pickup devices 101 to 103 are capable of observing two directions at the same time.

In addition, creatively using image pickup device main bodies so that a light of a different wavelength is received by each image pickup device main body, such as receiving visible light by one of the image pickup device main bodies of an image pickup device and receiving infrared light by the other image pickup device main body, a multifunctional image pickup unit can be provided. It is obvious that each image pickup device main body can receive light in a wavelength band other than infrared light and visible light.

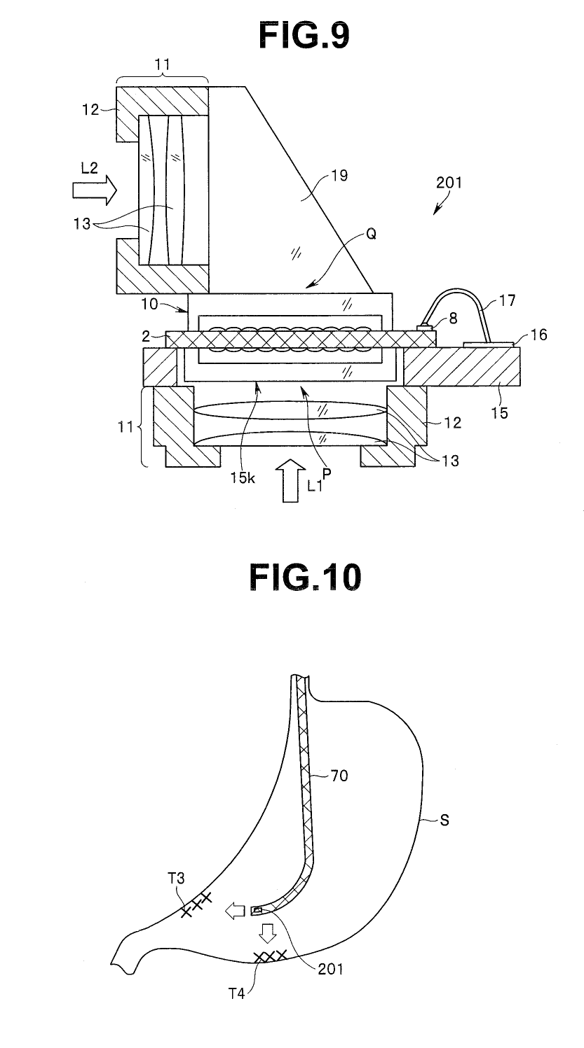

Furthermore, the optical elements positioned on the first side P and the second side Q of the image pickup device 1 are not limited to the lens unit 11. FIG. 9 is a diagram illustrating a modification in which an optical path conversion element including a lens unit is provided on a second side of the image pickup device illustrated in FIG. 8, and FIG. 10 is a diagram illustrating a state where a distal end-side of an insertion portion of an endoscope provided with the image pickup unit illustrated in FIG. 9 has been inserted inside a stomach.

As illustrated in FIG. 9, an optical path conversion element, such as a prism 19, which is an optical element including the lens unit 11 may be provided on the second side Q of the image pickup device 1. Moreover, the optical path conversion element may be a mirror or the like.

Consequently, a single image pickup device 1 can pick up images of two subjects positioned in directions that differ from each other by 90°. Specifically, as illustrated in FIG. 9, images of two subjects positioned below and to the front of the an image pickup unit 201 can be picked up without having to change the position of the image pickup device 1. Moreover, the direction of the light L2 to be converted by 90° by the prism 19 is not limited to frontward and may alternatively be rearward or sideways by varying the mounting position of the prism 19.

In addition, by providing the image pickup unit 201 configured as described above on the distal end-side of the insertion portion 70 of an endoscope, in the same manner as the image pickup unit 200, a small-size and small-diameter endoscope for both front view and side view can be realized.

Specifically, as illustrated in FIG. 10, when the inside of a stomach S is observed using an endoscope in which the image pickup unit 201 is provided inside the distal end-side of the insertion portion 70 of the endoscope, observations of a pylorus T3 and a stomach wall T4 can be performed without having to change the position of the image pickup device 1. Therefore, since endoscopic observations can be performed with less conversions of an insertion posture of the endoscope, the burden to be placed on a subject being observed can be alleviated.

In addition, the prism 19 including the lens unit 11 may also be provided on the first side P of the image pickup device 1. Furthermore, in this case, each lens unit 11 may observe a different direction.

Moreover, while an example has been shown in which the image pickup apparatus 10 including the image pickup device 1 shown in the first embodiment is to be used in the image pickup unit 201, such a configuration is not restrictive and the image pickup apparatus 10′ including any of the image pickup devices 101 to 103 according to the second to fourth embodiments can be used instead. In this case, the image pickup devices 101 to 103 are capable of observing two directions at the same time.

In addition, when the prism 19 including the lens unit 11 is provided on both the first side P and the second side Q of the image pickup devices 101 to 103, while the image pickup devices 101 to 103 become able to observe the same direction at the same time, performing simultaneous observation further enables stereoscopic viewing of a subject.

Furthermore, by receiving visible light from one of the lens units 11 and receiving infrared light from the other lens unit, lights with wavelength bands that differ from each other can be received from the same object. It is obvious that each lens unit 11 can receive light in a wavelength band other than infrared light and visible light. Moreover, the optical element may be an optical filter that blocks light of a particular wavelength.

In addition, inventions of various stages are included in the embodiments described above, and various inventions can be extracted by appropriately combining the plurality of essential components disclosed therein. For example, even when some essential components are deleted from all essential components shown in one of the aforementioned embodiments, if the problem to be solved in the present invention is solvable and the advantageous effect of the present invention is attainable, then a configuration from which these essential components have been deleted can be extracted as an invention.

For example, even when some essential components are deleted from all essential components shown in the embodiments, if the problem to be solved in the present invention is solvable and the advantageous effect of the present invention is attainable, then a configuration from which these essential components have been deleted can be extracted as an invention.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An image pickup device comprising
two surfaces into which light enters from two opposing directions.

2. The image pickup device according to claim 1, comprising:
an image pickup device main body having a semiconductor substrate provided with a light-receiving section and a wiring layer laminated on the semiconductor substrate;
a first surface positioned on the image pickup device main body on the side of the wiring layer; and
a second surface positioned on the image pickup device main body on the side of the semiconductor substrate so as to oppose the first surface.

3. The image pickup device according to claim 2, wherein
the image pickup device is made of a single image pickup device main body and light can enter the light-receiving section from two directions into two surfaces, namely, the first surface and the second surface, and
the single image pickup device main body comprises a light-shielding member which shields the second surface when light is allowed to enter to the light-receiving section from the first surface and which shields the first surface when light is allowed to enter to the light-receiving section from the second surface.

4. The image pickup device according to claim 2, wherein
the image pickup device is made of two image pickup device main bodies, and
the image pickup device includes two surfaces into which light enters from two opposing directions in such a way that light enters the light-receiving section of one of the image pickup device main bodies via any of the first surface and the second surface of the one of the image pickup device main bodies and light enters the light-receiving section of the other image pickup device main body via any of the first surface and the second surface of the other image pickup device main body.

5. The image pickup device according to claim 4, wherein
the second surface of the other image pickup device main body is arranged so as to oppose the second surface of the one of the image pickup device main bodies, and
light enters the light-receiving section of one of the image pickup device main bodies via the first surface of the one of the image pickup device main bodies and light enters the light-receiving section of the other image pickup device main body via the first surface of the other image pickup device main body.

6. The image pickup device according to claim 4, wherein
the second surface of the other image pickup device main body is arranged so as to oppose the first surface of the one of the image pickup device main bodies, and
light enters the light-receiving section of one of the image pickup device main bodies via the second surface of the one of the image pickup device main bodies and light enters the light-receiving section of the other image pickup device main body via the first surface of the other image pickup device main body.

7. The image pickup device according to claim 4, wherein
the first surface of the other image pickup device main body is arranged so as to oppose the first surface of the one of the image pickup device main bodies, and
light enters the light-receiving section of one of the image pickup device main bodies via the second surface of the one of the image pickup device main bodies and light enters the light-receiving section of the other image pickup device main body via the second surface of the other image pickup device main body.

8. The image pickup device according to claim 4, wherein
a light-shielding layer is provided between the one of the image pickup device main bodies and the other image pickup device main body.

9. The image pickup device according to claim 8, wherein
the light-shielding layer is made of an adhesive that adheres the one of the image pickup device main bodies to the other image pickup device main body.

10. An image pickup unit comprising:
an image pickup device including two surfaces into which light enters from two opposing directions;
an image pickup device main body including a semiconductor substrate provided with a light-receiving section and a wiring layer laminated on the semiconductor substrate;
a member to be fixed that fixes the image pickup device and in which an opening is formed at a position that overlaps the light-receiving section of the image pickup device in a plan-viewed state; and
optical elements respectively provided on a first side of the image pickup device main body which overlaps the light-receiving section via the opening in a plan-viewed state and on a second side of the image pickup device main body opposite to the first side which overlaps the light-receiving section in a plan-viewed state.

11. The image pickup unit according to claim 10, wherein
the optical elements are lens units.

12. The image pickup unit according to claim 10, wherein
the optical elements are optical path conversion elements including lens units.

13. An endoscope comprising:
the image pickup unit according to claim 10; and
an insertion portion which includes the image pickup unit and which is to be inserted into a subject to be tested.
